(19) United States
(12) Patent Application Publication
(10) Pub. No.: US 2021/0174403 A1
(43) Pub. Date: Jun. 10, 2021

(54) NEXT BEST ACTION MANAGEMENT PLATFORM

(71) Applicant: Accenture Global Solutions Limited, Dublin (IE)

(72) Inventors: Davide Guglielmo BELLINI, Cernusco Sul Naviglio (IT); Danilo RIZZO, Cologno Monzese (IT); Paolo CANALETTI, Milano (IT)

(21) Appl. No.: 16/703,492

(22) Filed: Dec. 4, 2019

(51) Int. Cl. G06Q 30/02; G06Q 10/06; H04M 3/51; G06F 40/30

(52) U.S. Cl. CPC G06Q 30/0281; G06Q 30/0201; G06F 40/30; H04M 3/5175; G06Q 10/06316

(57) ABSTRACT

An NBA management platform may receive simulation data for an interaction involving a service, wherein the simulation data includes: a set of operational parameters associated with the interaction, subscriber information for a set of subscribers associated with the service, and a set of rules associated with providing the service. The NBA management platform may process, using a simulation model, the simulation data to determine a simulation outcome of the interaction according to the simulation data. The NBA management platform may determine whether the simulation outcome satisfies a next best action threshold. The NBA management platform may provide a next best action output to enable a next best action for engaging in the interaction.

### BACKGROUND

A next best action (NBA) involves performance of one or more activities involving a service or product to provide an optimal benefit associated with the service or product. An NBA for an entity (e.g., an individual or organization) may correspond to a solution for a sales campaign, a marketing campaign, an operation of the entity, and/or the like.

### SUMMARY

According to some implementations, a method may include receiving simulation data for a customer interaction involving a customer service, wherein the simulation data includes: a set of operational parameters associated with the customer interaction, subscriber information for a set of customer subscribers associated with the customer service, and a set of rules associated with providing the customer service; processing, using a simulation model, the simulation data to determine a simulation outcome of the customer interaction according to the simulation data; determining that the simulation outcome does not satisfy a next best action threshold; and determining, based on determining that the simulation outcome does not satisfy the next best action threshold, an updated set of rules to change a service agreement associated with providing the customer service.

According to some implementations, a device may include one or more memories, and one or more processors, communicatively coupled to the one or more memories, configured to: receive simulation data associated with engaging in an interaction involving a service, wherein the simulation data is associated with a set of users and a set of rules for providing the service to the set of users; simulate, using a simulation model, the interaction according to the simulation data to determine a probability of a desired outcome of the interaction according to the simulation data, wherein the simulation model is trained according to historical data associated with a plurality of previous interactions involving the service; determine whether the probability satisfies a next best action threshold; and when the probability satisfies a next best action threshold: provide a next best action output according to the simulation data to permit performance of a next best action associated with providing the service to the set of users according to the set of rules; or when the probability does not satisfy the next best action threshold: determine updated simulation data that causes the probability of the desired outcome to satisfy the next best action threshold, wherein the updated simulation data includes an adjustment to the set of rules, and provide a next best action output according to the updated simulation data to permit performance of a next best action associated with providing the service to the set of users according to the adjustment to the set of rules.

According to some implementations, a non-transitory computer-readable medium may store one or more instructions. The one or more instructions, when executed by one or more processors, may cause the one or more processors to: monitor an ongoing interaction between a service representative and a user; determine simulation data for the ongoing interaction, wherein the simulation data includes: a set of operational parameters associated with the ongoing interaction, user information associated with the user, and an initial set of rules associated with providing a service to the user; process, using a simulation model and during the ongoing interaction, the simulation data to predict a probability of a desired outcome of the ongoing interaction according to the simulation data, wherein the simulation model is trained according to historical data associated with a plurality of previous interactions corresponding to the ongoing interaction and a plurality of subscribers of the service; determine that the probability does not satisfy a next best action threshold; determine, based on determining that the probability does not satisfy the next best action threshold, an updated set of rules that, when processed using the simulation model, cause the probability to satisfy the next best action threshold, generate a next best action output according to the updated set of rules; and provide the next best action output to a user device of the service representative to enable the service representative to perform a next best action during the ongoing interaction.

### BRIEF DESCRIPTION OF THE DRAWINGS

FIGS. 1A and 1B are diagrams of one or more example implementations described herein.

FIG. 2 is a diagram of an example architecture of a next best action management platform described herein.

FIGS. 3A-3C are diagrams of one or more example implementations described herein.

FIG. 4 is a diagram of an example environment in which systems and/or methods described herein may be implemented.

FIG. 5 is a diagram of example components of one or more devices of FIG. 4.

FIGS. 6-8 are flowcharts of one or more example processes associated with a next best action management platform.

### DETAILED DESCRIPTION

The following detailed description of example implementations refers to the accompanying drawings. The same reference numbers in different drawings may identify the same or similar elements.

A service manager (e.g., a product manager, a manager, a sales manager, and/or the like) and/or service representative (e.g., a sales representative) may encounter challenges determining a next best action (NBA) that is to be taken in association with a service and/or an operation associated with an entity that provides the service (or, correspondingly, a product). Incorrectly selecting an action and/or performing an improper action (or an action that would not be considered, after the fact, to be an NBA) can have negative consequences with respect to a performance of the service and/or correspondingly may result in a waste of resources. For example, computing resources, network resources, and/or the like may be wasted by performing an action (e.g., offering a service, manufacturing a part, hiring a staff member, and/or the like) that was not proper according to certain circumstances of the action. Furthermore, customer satisfaction may correspond to an expected performance versus an actual performance or results associated with a service or product, and correspondingly, can directly impact a success of the service. Therefore, performing an undesirable action that is undesirable to an individual a customer, which would not correspond to an NBA for an interaction with that customer, may be detrimental to a success of a relationship with that customer and/or a success of the service. Accordingly, objectively determining an NBA in advance, whether for interactions with customers and/or for certain operations of an entity, can benefit or assist with the success of a service and/or an operation associated with the service.

According to some implementations, an NBA management platform may utilize one or more models (e.g., machine learning models, artificial intelligence models, simulation models, and/or the like) to determine an NBA associated with a service or an interaction involving the service. For example, the NBA management platform may simulate a plurality of potential actions that can be taken based on rules associated with a service (e.g., business rules, transaction rules, and/or the like), operational data, and/or individuals associated with the service (e.g., subscribers and/or potential subscribers) to determine the NBA and/or select the NBA from the plurality of potential actions.

The NBA management platform may be customizable with multiple configuration options to adapt to a variety of different scenarios associated with different projects, different objectives, different constraints (e.g., associated with the rules), different consumers, different service representatives, and/or different service teams. An adaptive simulation model associated with the NBA management platform may be configured for any project regardless of delivery model, industry, and/or practice. The NBA management platform may indicate the next best action according to the input simulation parameters, according to one or more trends associated with the product, and/or the like.

Accordingly, the NBA management platform may simulate scenarios and/or tune rules associated with an operation involving a product or service. A decision framework (or architecture) may be vertical to a particular industry to permit monitoring and/or tracking of trends associated with the operation. In this way, an operation associated with the product or service (e.g., a marketing campaign, a sales campaign, a production campaign, and/or the like) can better predict an outcome by simulating different scenarios and tune the rules accordingly.

In this way, the NBA management platform, as described herein, may quickly and efficiently (e.g., relative to previous techniques) determine an NBA associated with a service, thereby conserving computing resources (e.g., processor resources, memory resources, used to analyze the service, determine whether a NBA is needed in associated with the service, determining the NBA, generating or providing the NBA, performing the NBA, and/or the like). Furthermore, implementations described herein use a rigorous, scalable computerized process (e.g., in association with and/or for thousands, millions, or more subscribers of a service, subscriptions for a service, transactions involving the service, and/or the like) to perform tasks or roles (e.g., simultaneously on the thousands, millions, or more the subscribers of a service, the subscriptions for a service, the transactions involving the service, and/or the like) that were not previously performed. For example, previously, a technique did not exist to analyze service performance data associated with a service, receive or determine simulation data for use in determining an NBA associated with the service and/or a consumer of the service, and facilitate performance of the NBA to enable the service to be provided to the consumer. Furthermore, a process for determining and/or performing an NBA, as described herein, conserves computing resources (e.g., processor resources, memory resources, and/or the like) that would otherwise be wasted in attempting to perform actions that are not an NBA according to one or more models described herein.

Although certain examples are described herein in connection with an offer to a consumer, similar processes may be applied with other types of individuals and/or in other applications, operations, industries, and/or the like. For example, the NBA management platform, as described herein, may be configured to determine an NBA for a manufacturing operation, a staffing operation, a real-estate operation, or any other type of business operation.

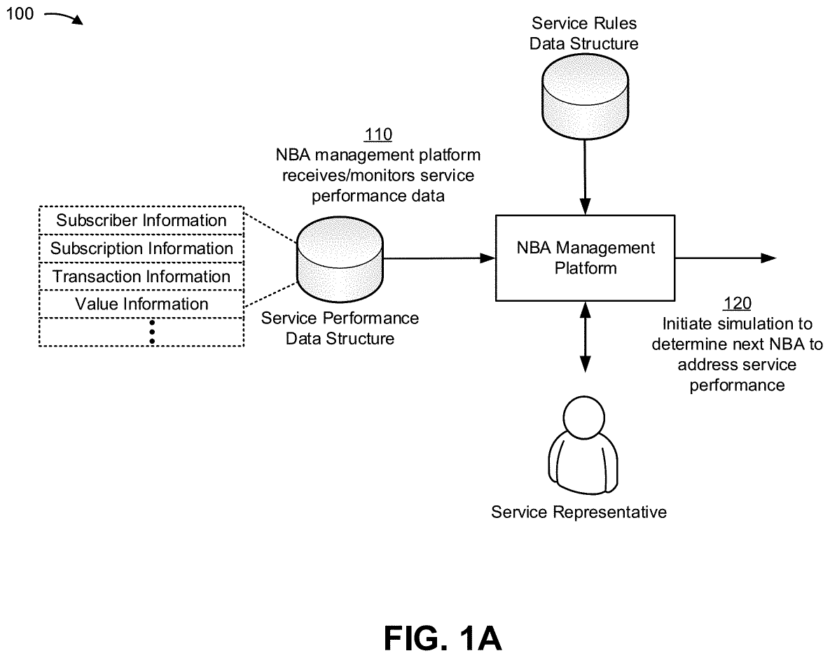

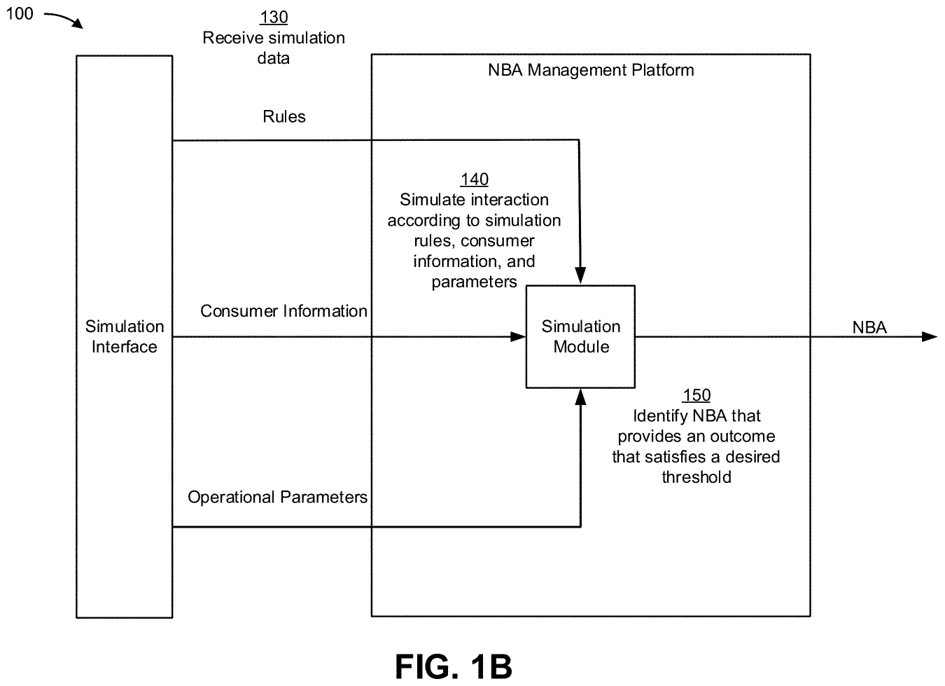

FIGS. 1A and 1B are diagrams of an example implementation 100 described herein. Example implementation 100 includes an NBA management platform, a service performance data structure, a service rules data structure, and a simulation interface. The NBA management platform, in example implementation 100, includes a simulation module to run a simulation using simulation data. As described herein, the NBA management platform may simulate, according to a set of simulation parameters, performance of a set of actions to determine an NBA based on the set of simulation parameters. While certain examples may be described herein in connection with a service (or providing a service), other examples may correspondingly apply to a product, produce, or other type of consumer based goods.

As shown in FIG. 1A, and by reference number 110, the NBA management platform receives and/or monitors service performance data in the service performance data structure. The service performance data may be associated with a particular service that is provided by an entity. As shown, the service performance data may correspond to and/or include subscriber information (e.g., account information, personal information, financial information, and/or the like associated with subscribers of the service), subscription information (e.g., information that identifies terms of active subscriptions for the service), transaction information (e.g., information that identifies a transactional history associated with the service), value information (e.g., information that indicates and/or tracks revenue information associated with the service, subscribers, and/or the like) associated with the service, and/or the like. Accordingly, the service performance data may include historical data associated with the service, subscribers of the service, subscriptions for the service, transactions involving the service, and/or a value of the service.

The service performance data structure may be populated or include data that is generated and/or stored in the service performance data using any suitable technique (e.g., by a user, by an application programming interface (API), and/or the like). In this way, the service performance data may include data that tracks and/or maintains information associated with a performance of the service, individuals registering and/or creating an account for the service, transactions involving the service being registered, and/or the like.

The NBA management platform may receive the service performance data from the service performance data structure. In some implementations, the NBA management platform may track and/or monitor service performance data in the service performance data structure to identify trends associated with a particular service (e.g., a media service, a network or communication service, a retail service, an operational service, and/or the like). For example, a trend analysis model may be configured to identify patterns of activity associated with the service. The trend analysis model may be configured to track changes in the service performance data to detect patterns corresponding to the changes. Such trends may include active subscriptions increasing or decreasing (e.g., based on detecting whether new subscribers are being added or leaving, length of subscriptions, and/or the like), a value (e.g., average by subscriber) of the service (e.g., relative to the entity) increasing or decreasing, and/or the like. In some implementations, a service representative (or service manager) associated with the entity may track and/or monitor the service performance data (e.g., via reports, scanning the data, and/or the like).

As described herein, the NBA management platform may receive and/or obtain simulation data from the service performance data to perform a simulation to identify an NBA associated with an interaction involving the service. Such an interaction may include an interaction with one or more subscribers (or users) of the service and/or one or more potential subscribers to the service (which may be referred to collectively herein as “consumers”). For example, the interaction may include a sales campaign to increase a number of subscribers, a marketing or advertising campaign to share information about the service and/or improve a value of the service, and/or the like.

The simulation data may include a set of operational parameters associated with the interaction. For example, the operational parameters may include potential communication mediums for the interaction (e.g., phone call with a service representative, text message, email, instant messaging, chatbot interaction, and/or the like). Furthermore, the simulation data may include subscriber information associated with a particular set of subscribers. The set of subscribers may correspond to a group of subscribers that have a same characteristic (e.g., length of subscription, location, service level agreement terms, paying the same fee for the subscription, and/or the like). In some implementations, the set of subscribers may be associated with a target group of consumers associated with the interaction (e.g., a group of subscribers that will be targeted to renew a subscription, a group of potential subscribers to sign-up for the service, and/or the like). Furthermore, the simulation data may include a set of rules associated with the service. The set of rules may include and/or correspond to constraints associated with providing the service. For example, the rules may define bounds of one or more terms of a service level agreement between the consumers and entity involving the service (e.g., a minimum fee, a minimum term of the transaction agreement, whether or not a cancellation fee is to be included, and/or the like). In this way, the set of rules may correspond to a range of values for certain terms. As shown, the set of rules may be received from the service rules data structure, which may be maintained by the entity (e.g., according to certain business practices, analytics associated with the service, and/or the like).

In this way, the NBA management platform may receive service performance data and/or simulation data associated with the service to permit the NBA management platform to determine an NBA associated with the service.

As further shown in FIG. 1A, and by reference number 120, the NBA management platform initiates a simulation to determine the NBA to address the service performance. In some implementations, the NBA management platform may initiate the simulation according to a user input and/or based on detecting a trend associated with the service. For example, based on the service performance data indicating (e.g., as detected by the trend analysis model and/or the service representative) a negative trend involving the service (e.g., a drop in subscribers, a drop in revenue, a degradation of performance of the service, and/or the like), the NBA management platform may initiate a simulation to identify an NBA to remedy or address the negative trend. In some implementations, the negative trend may be associated with a single subscriber and/or a group of subscribers.

As an example, the negative trend may correspond to a single subscriber frequently complaining about the service (as indicated in subscriber information of the service performance data). In such a case, an NBA may include contacting the subscriber to ensure that the subscriber is retained and/or maintains the subscription with the entity. Further, such an NBA may include offering an adjustment to the terms of the service agreement with the subscriber, offering a credit on a transaction for the service and/or the like. As another example, the negative trend may be across a group of subscribers (e.g., detecting an outage of the service in a particular area). In some implementations, the NBA management platform may be configured to determine an NBA that can be performed during individual interactions with the group of subscribers. Moreover, the NBA management platform may determine individual NBAs that can be performed during the individual interactions (e.g., so that the NBAs are customized to the individual subscribers).

In this way, the NBA management platform (e.g., based on identifying or receiving information indicating that a negative trend involving the service exists) may initiate and/or perform a simulation (or series of simulations) to determine an NBA associated with the service.

As further shown in FIG. 1B, and by reference number 130, the NBA management platform receives simulation parameters to determine the NBA. As shown, the simulation data may include simulation rules, simulation user information, and simulation parameter values. The NBA management platform may receive the simulation data from a simulation interface, which may be a part (or module) of the NBA management platform and/or communicatively coupled to the NBA management platform. The simulation interface may include a user interface (e.g., a user interface of a user device of the service representative) to permit the service representative to provide adjustments to information associated with the simulation data.

Additionally, or alternatively, the simulation interface may include an API that is configured to determine and/or provide adjustments to the service performance data. In such a case, the simulation interface may include a scenario generator model that is configured to adjust the service performance data to provide the simulation parameters that are based on the service performance data. As described herein, the simulation data may be specific to a particular subscriber and/or a set of subscribers. The scenario generator model may be a machine learning model that is trained to determine simulation data for a simulation model configured to determine an NBA associated with a service. For example, the NBA management platform may train the scenario generator model based on one or more scenario generating parameters, such as the rules associated with the service, subscriber information associated with target consumers of the NBA, operational parameters for an interaction involving the NBA, and/or the like. The one or more rules may include business rules (e.g., metrics for the service, such as desired subscription quantity, desired value of the service, and/or the like), transaction rules (e.g., minimum or maximum fees for the service, minimum or maximum penalty fees, types of fees involving the service, and/or the like), terms of a service agreement (e.g., fee amount, performance characteristics, duration of agreement, and/or the like), and/or the like. The subscriber information may include information for target consumer(s) of the NBA, such as a target-specific location, age, length of subscription, type of subscription (e.g., monthly, annual, rolling renewable subscription, fixed-term subscription, and/or the like), subscription status (e.g., in good standing or not in good standing), and/or the like. The operational parameters may include available types of communication media to use (and/or characteristics of the communication media, such as location of use, time of use, and/or the like), contextual information associated with the service or condition of the service (e.g., service experiencing degraded performance, drop in subscriptions, and/or the like), conditional information associated with the interaction (e.g., sentiment of subscriber, subscriber satisfaction with service, time of interaction, and/or the like), and/or the like).

The NBA management platform may train the scenario generator model using historical data associated with determining the simulation data according to the one or more scenario generating parameters. Using the historical data and the one or more scenario generating parameters as inputs to the scenario generator model, the simulation interface (and/or the NBA management platform) may determine the simulation data for simulating one or more actions of an interaction to determine an NBA for the interaction.

In this way, the NBA management platform may receive the simulation data to permit the NBA management platform to perform one or more simulations to determine an NBA for an interaction involving the service.

As further shown in FIG. 1B, and by reference number 140, the NBA management platform (e.g., via the simulation module) simulates interactions according to simulation rules, consumer information, and operational parameters received via the simulation interface. For example, the NBA management platform, via a simulation module, may process the simulation data to determine a simulation outcome of an interaction according to the simulation data. The simulation outcome may correspond to a probability of a positive result or negative result associated with the interaction (e.g., whether or not the consumer continues to be or becomes a subscriber of the service, whether a value of the service improves or declines, and/or the like).

As a more specific example, if the simulation data includes or represents rules indicating that terms of a service agreement for the service include monthly payments of a particular value for a particular length of time, that the interaction is to involve a service representative calling a subscriber, and that the subscriber is in good standing and has been a subscriber for a particular length of time, the simulation module, using a simulation model, may determine an outcome from such an interaction that corresponds to whether that specific consumer engages (or is likely to engage) in that specific service agreement. As another example, if the simulation data includes information identifying that an advertisement for an offer for the service is to be placed on a billboard in a particular area of a target consumer, the simulation model may be configured to determine a simulation outcome that indicates whether a quantity of subscribers associated with the target consumer in that area is likely to increase or decrease based on the advertisement on the billboard.

In some implementations, the simulation model may include or correspond to a machine learning model to determine an outcome (or a probability of an outcome) of an interaction according to the simulation data. For example, the NBA management platform may train the simulation model based on simulation inputs (e.g., respective values, characteristics, information, and/or the like) of the simulation data associated with the rules, consumer information, and/or operational parameters used to perform the simulation. The NBA management platform may train the simulation model with historical data associated with results of previous interactions involving rules, consumer information, and operational parameters that correspond to the inputs (e.g., values, characteristics, information, and/or the like in the simulation data). Using the historical data and the simulation data as inputs to the simulation model, the NBA management platform (and/or simulation module) may determine a simulation outcome (and/or probability of the simulation outcome) to determine whether the simulation data is representative of an NBA for an interaction involving the service. For example, if the simulation data indicates a particular threshold probability of success (e.g., at least a 70% probability of a positive outcome, a 90% probability of a positive outcome, a 99% probability of a positive outcome, and/or the like), the NBA management platform may determine that an NBA is to be performed according to the rules and/or parameters in an interaction with a user associated with the consumer information.

In some implementations, the simulation model of the NBA management platform may include or correspond to a scoring system (e.g., with relatively high scores and/or relatively low scores) to identify and/or classify the rules, consumer information, and/or operational parameters as being likely to provide a particular positive outcome or negative outcome. For example, the simulation model may determine that a relatively high score (e.g., as being likely to provide a positive outcome) is to be assigned to values of rules, consumer information, and/or parameters that have been historically determined to be likely to provide a positive outcome from a particular interaction. In contrast, the NBA management platform may determine that a relatively low score (e.g., as being unlikely to provide a positive outcome) is to be assigned to values of the rules, consumer information, and/or operational parameters that have been historically determined to be likely to provide a negative outcome from that particular interaction.

In some implementations, to determine a score for a particular simulation, the simulation model (and/or NBA management platform) can utilize a scoring system (e.g., a probability scoring system) to determine a probability associated with an outcome of the simulation based on values of the rules, consumer information, and operational parameters in the simulation data. In some implementations, the simulation model can apply weights (w) to parameters corresponding to individual values of the rules, individual values of the consumer information, and/or individual values of the operational parameters. Accordingly, the simulation model can determine (e.g., via one or more calculations associated with the scoring system) scores for simulation values of the simulation data based on the scoring system that are representative of whether the simulation values are more likely to provide a positive outcome for an interaction or more likely to provide a negative outcome for the interaction (e.g., according to historical data associated with previously performed interactions). As an example, the simulation model can use the following to determine the score of a simulation outcome (sᵢⱼ) based on simulation values for rules a, b, c of simulation data i for a potential interaction j involving a consumer and operations parameters of the simulation data i:

sᵢⱼ=wₐⱼaᵢ+w_{bj}bᵢ+w_{c}cᵢ+ . . . (1)

where wₐⱼ, w_{bj}, w_{cj} correspond to adjusted weights based on the relevance of rules aᵢ, bᵢ, cᵢ to the interaction j. For example, parameters aᵢ, bᵢ, cᵢ may include a value (e.g., a fee amount, a length of a service agreement, a length of an operation associated with the service, and/or the like) associated with a scale for the respective rules aᵢ, bᵢ, cᵢ. In some implementations, the adjusted weights wₐⱼ, w_{bj}, w_{cj} may be normalized (e.g., where 0<wₐⱼ, w_{bj}, w_{cj}<1 and wₐⱼ+w_{bj}+w_{cj}=1). In this way, the simulation model may use a scoring system to determine a probability that an interaction performed based on information in the simulation data is a desired outcome (e.g., a positive outcome).

In this way, according to the simulation data, the NBA management platform may simulate an interaction involving an action defined by the rules, that would be performed with a consumer that is associated with the consumer information, and that would be performed in a manner according to the operational parameters indicated in the simulation data.

As further shown in FIG. 1B, and by reference number 150, the NBA management platform identifies an NBA from the simulation that provides an outcome that satisfies a desired threshold (which may be referred to herein as an “NBA threshold”). For example, the desired threshold may correspond to a threshold probability (e.g., 50% likely, 75% likely, 80% likely, and/or the like) of a desired outcome. The threshold probability may be a fixed threshold probability or a variable threshold probability that depends on one or more of the inputs of the simulation data.

According to some implementations, after each simulation, if the NBA management platform determines that the simulation outcome does not satisfy an NBA threshold, the NBA management platform may cause the simulation model to re-simulate the interaction based on adjusted simulation data. For example, the NBA management platform, via the scenario generator model, may generate and/or receive updated simulation data (e.g., from the simulation interface) and use the simulation model to perform a second simulation according to the updated simulation data. The updated simulation data may include a change to one or more of the rules (e.g., by altering a weighting parameter of a rule, adding a new rule to the simulation data, removing a rule from the simulation data, and/or the like), consumer information, and/or operational parameters of the simulation data. In some implementations, the NBA management platform may iteratively perform such a process until an NBA threshold is satisfied.

In some implementations, NBA management platform may cause the scenario generator model to determine updated simulation data according to a particular priority (e.g., corresponding to a preference of the service representative, a preference of the entity, and/or the like) relative to the inputs of the simulation data. For example, the NBA management platform may train the scenario generator model to update rules (or certain rules) associated with the service, before adjusting consumer information and/or operational parameters. More specifically, the NBA management platform may train (e.g., according to a certain priority) the scenario generator model to alter one or more weighting parameters of the rules, add a new rule, and/or remove one or more rules when updating the simulation data to determine updated simulation data. Additionally, or alternatively, the NBA management platform may configure the scenario generator model to only update certain inputs (or certain characteristics of the inputs) to perform a subsequent simulation. For example, the NBA management platform may train the simulation model to only adjust rules to determine the updated simulation data. Additionally, or alternatively, the NBA management platform may train the simulation model to only adjust the rules according to a particular priority, such that the rules are adjusted between iteratively simulating the interaction according to the iteratively updated rules of the simulation data.

As a more specific example, if a negative outcome is determined from a simulation of an interaction involving an offer for a service agreement with a consumer over the phone, the scenario generator model may be configured to, without adjusting consumer information or operational parameters, first adjust a fee for the service in the offer, to enable the simulation model to simulate the interaction with the adjusted fee. In such an example, if a subsequent simulation (or multiple simulation outcomes) does not satisfy an NBA threshold until the fee reaches a threshold value (e.g., a minimum or maximum for the service), the scenario generator may iteratively adjust a term of the service agreement of the offer (e.g., by extending the term until the NBA threshold is satisfied). In such a case, the NBA management platform may determine terms of a service agreement (e.g., from the values of the simulated rules) that satisfy the NBA to permit the NBA to be performed during an actual interaction with a subscriber or potential subscriber to improve the likelihood of a positive result of the interaction.

In a similar manner, the scenario generator model may be configured to be primarily focused on adjusting the operational parameters. For example, the scenario generator may adjust the operational parameters for various contexts involving the service. Accordingly, the scenario generator model may adjust contextual information associated with the interaction, such as the type of communication medium to use, the performance of the service, a sentiment of the consumer during the interaction, market information associated with the service, and/or the like. Moreover, the scenario generator may be configured to focus adjustment of the consumer information to determine or provide updated simulation data. For example, the scenario generator may be configured to adjust the consumer information for a specific subscriber, for various groups of subscribers, and/or for various groups of potential subscribers. Accordingly, the scenario generator may adjust the consumer information to simulate interactions involving subscribers experiencing technical problems with the service, subscribers with subscriptions having a threshold duration, subscribers in good standing (or not in good standing), potential subscribers with a particular area, age group, and/or other demographic.

According to some implementations, the updated simulated data may be determined and/or received via the simulation interface based on a user input. For example, the service representative may provide a user input that identifies an adjustment to the simulation data to cause the NBA management platform to re-simulate a simulation to determine the NBA. Additionally, or alternatively, the user input may correspond to an approval of an adjustment to the simulated data. For example, after an adjustment is made, the NBA management platform may prompt, via the simulation interface, the service representative to approve suggested updated simulation data (e.g., determined by the scenario generator model, as described herein). The NBA management platform may prompt the service representative via a graphical user interface (GUI) of the simulation interface, via a notification (e.g., a message to a user device of the service representative), and/or the like. Accordingly, in some implementations, the NBA management platform may automatically monitor the service performance data of a service, detect a negative trend associated with the service, determine an NBA for the service, and provide the NBA to the service representative to permit the service representative to perform the NBA. Additionally, or alternatively, the NBA management platform may perform the NBA using one or more user interface modules or devices (e.g., via a chatbot, a notification system (e.g., to email to text an offer to a consumer), and/or the like)

As shown in example implementation 100, the NBA management platform may generate and/or provide an NBA output. As described herein, the NBA output may correspond to an NBA associated with a service that is determined from one or more simulations of interactions involving the service. The NBA output may include instructions for performing the NBA that correspond to the inputs of the simulation data and/or updated simulation data if multiple simulations are performed. For example, the NBA may identify the rules for the interaction (e.g., terms of a service agreement for a sale, rules for a marketing campaign (e.g., budget, scheduling, and/or the like), manufacturing rules, real-estate rules, and/or the like), consumer information associated with a consumer of the interaction (e.g., information that identifies a target consumer), and/or operational parameters for the interaction (e.g., contact via a particular communication medium, at a particular time, during a particular time of year or performance level of the service, and/or the like). Accordingly, the service representative may perform the NBA by contacting a target consumer, via a particular communication medium, and in a particular manner corresponding to the simulation data that provided a likelihood of a positive outcome with the consumer (or a highest probability).

In this way, an NBA may be determined, provided, and/or performed to enhance a user experience associated with the service, to improve a performance of the service, to conserve resources associated with maintaining service performance data associated with the service, and/or the like.

As indicated above, FIGS. 1A and 1B are provided merely as one or more examples. Other examples may differ from what is described with regard to FIGS. 1A and 1B.

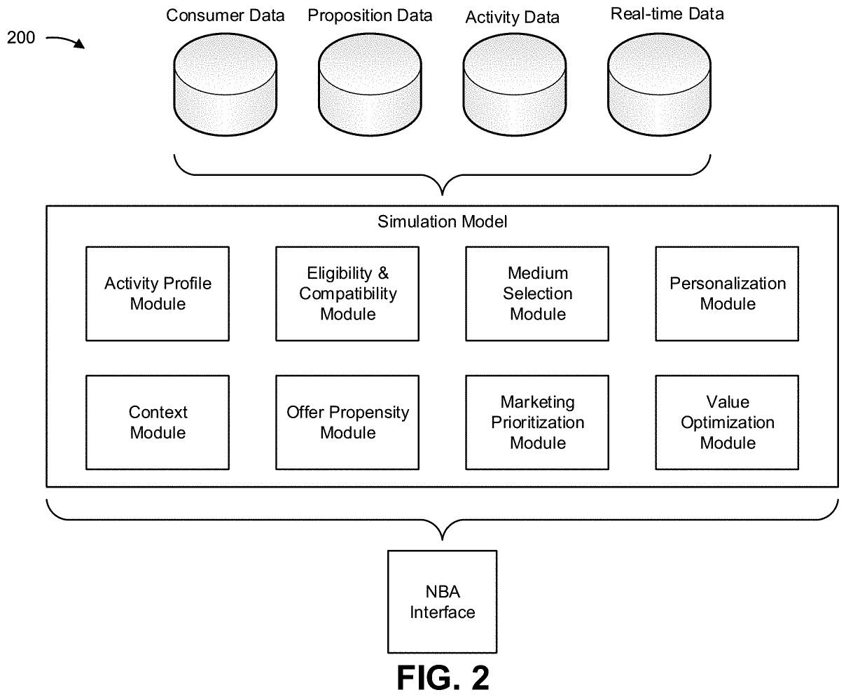

FIG. 2 is a diagram of an example architecture of an NBA management platform 200 described herein. As shown, the NBA management platform 200 of FIG. 2 includes a set of data sources, a simulation model, and an NBA interface. As described herein, the NBA management platform 200 may be configured to operate automatically and/or based on a user input from a service representative or other type of operator. The NBA management platform 200 of FIG. 2 may be configured for real-time use during an interaction. For example, a service representative may utilize the NBA management platform 200 to cause the simulation model to determine (e.g., via a plurality of iteratively performed simulations, as described herein) and provide, via the NBA interface, an NBA in real-time according to simulation data from the set of data sources. Accordingly, the service representative can perform the NBA with a consumer involved in the interaction to improve the likelihood of a positive outcome from the interaction (e.g., the consumer remains or becomes a subscriber of the service).

The set of data sources of NBA management platform 200 may include consumer data, proposition data, activity data, and real-time data. The set of data sources may include information that corresponds to the consumer information and/or operational parameters used by the simulation model. The consumer data may include personal information associated with a consumer (e.g., a consumer of the real-time interaction), such as consumer identification information, account information (if the consumer is a subscriber), subscription information of the consumer (e.g., if the consumer is or was ever a subscriber), and/or the like. The proposition data may include information (e.g. a list of propositions) associated with previous or outstanding offers made to the consumer for the service. The activity data may include activity information associated with the consumer, such as contact history, service usage, recorded satisfaction with the service, and/or the like.

The real-time data may correspond to text, audio, video, and/or image data associated with an interaction involving the consumer. Additionally, or alternatively, the real-time data may be associated with a service representative of the interaction (e.g., an identification of the service representative, a performance of the service representative, a title or role of the service representative, and/or the like). In some implementations, the real-time data may include or be associated with a natural language processing of the interaction (e.g., to determine a context of the interaction, a purpose of the interaction, and/or the like), a sentiment analysis of the interaction (e.g., to determine a sentiment of the consumer), and/or the like. Accordingly, the real-time data may provide contextual information associated with the interaction, the consumer, and/or the service representative.

As shown in FIG. 2, the simulation model may include a plurality of modules that are utilized to simulate an interaction and/or determine an NBA associated with the interaction. The plurality of modules of NBA management platform 200 include an activity profile module, an eligibility and compatibility module, a medium selection module, a personalization module, a context module, an offer propensity module, a marketing prioritization module, and a value optimization module. The simulation model may utilize one or more of the modules, which may be associated with one or more types of models (e.g., a machine learning model, a natural language processing model, a sentiment analysis model, a scoring model, and/or the like), to select historical data (e.g., from a data structure of NBA management platform 200) for performing a simulation of the interaction (e.g., including a subsequent action of the interaction). For example, the activity profile module may identify historical data associated with previous interactions with consumers that have the same or similar activity information that is included in the activity data. The eligibility and compatibility module may be used to determine whether consumer information (e.g., personal information, financial information, and/or the like) qualifies the individual for certain offers maintained or included in the marketing prioritization module (which may be used to define priorities for adjusting simulation data, as described herein). The medium selection module may be used to determine, according to contact history of the consumer, an optimal communication medium for the consumer and/or to detect and manage the communication medium of the interaction. The personalization module may be used to detect, according to the activity data and/or consumer information, preferences of the user. The context module (e.g., using a natural language processing model and/or a sentiment analysis model) may be used to identify a context of the interaction. The offer propensity module may be used to determine, according to activity data of the consumer and the real-time data, a probability that the consumer accepts a particular offer during the interaction. The marketing prioritization module may be used to determine, according to the proposition data and/or rules for the service, a next offer that is to be marketed to the consumer. The value optimization module may be used to determine whether the value is optimal for the user and/or an entity that is providing the service, to determine whether an NBA, involving the next offer, should be output for performance during the interaction.

The NBA interface may enable the service representative to receive a final NBA that is to be performed by the service representative. For example, the NBA output may include a prioritized list of propositions that are recommended for the user during the interaction, an optimal communication medium to use during the interaction, and/or any personalized information associated with the consumer (e.g., address the consumer by a particular name, in a particular manner, include certain personal information associated with the consumer, and/or the like).

In this way, an NBA management platform may have an architecture that permits simulation of an interaction to identify and/or provide an NBA as described herein. As indicated above, FIG. 2 is provided merely as one or more examples. Other examples may differ from what is described with regard to FIG. 2.

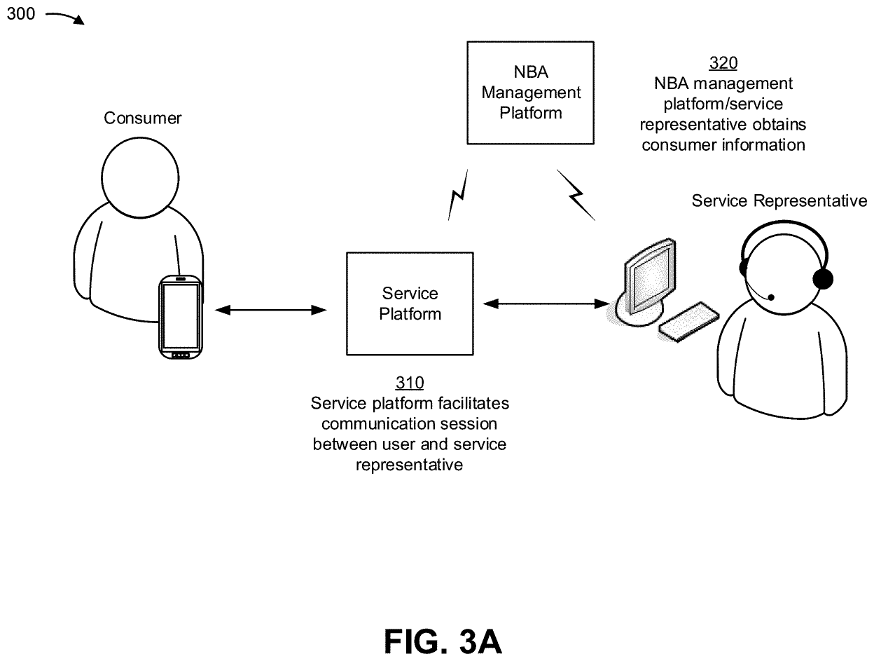

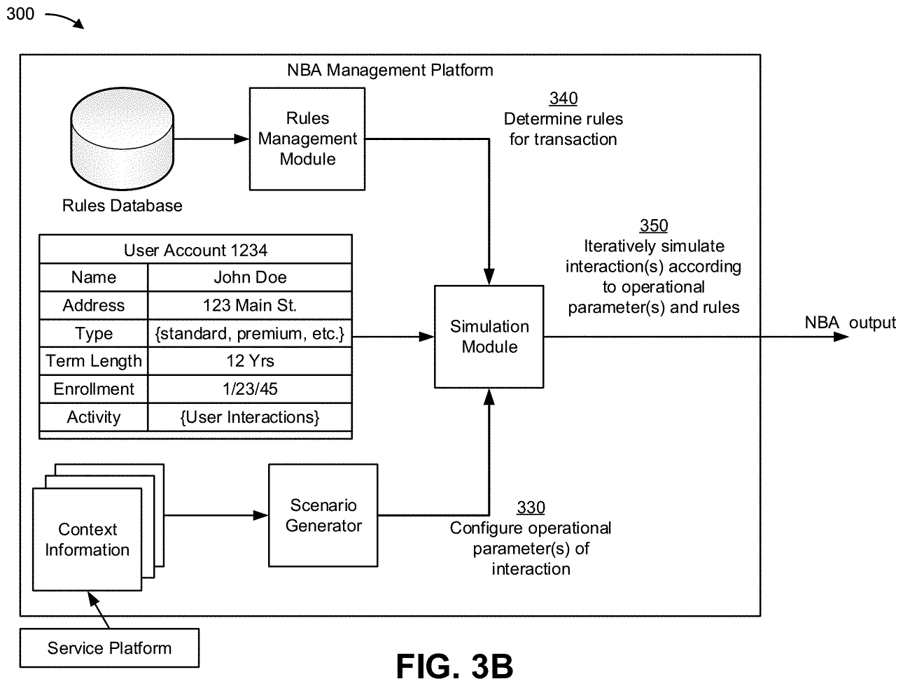

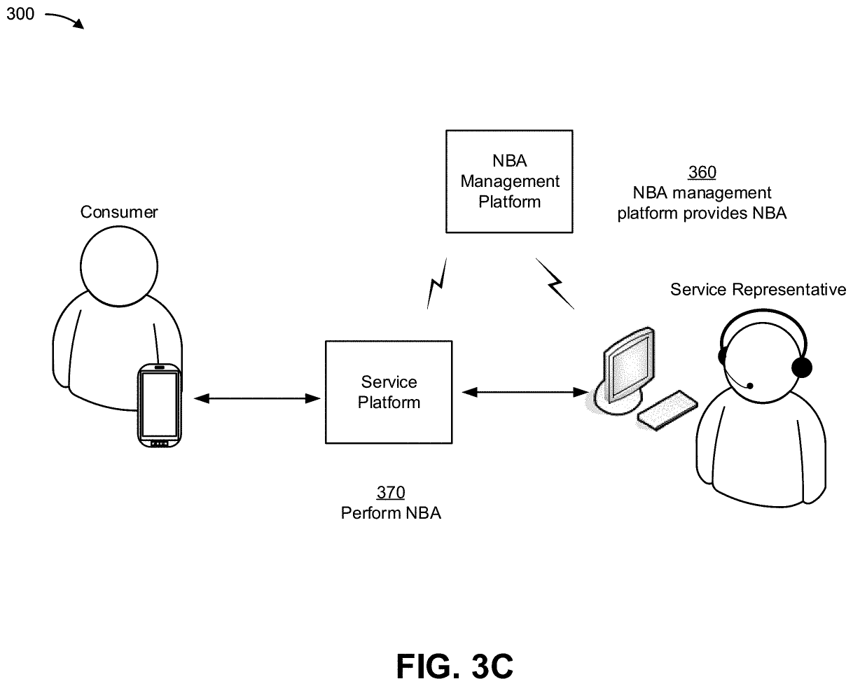

FIGS. 3A-3C are diagrams of an example implementation 300 described herein. Example implementation 300 includes a service platform, an NBA management platform, a user device of a consumer, and a service representative device of a service representative. In example implementation 300, the consumer and service representative are engaged in an interaction (e.g., a customer interaction) via the service platform.

As shown in FIG. 3A, and by reference number 310, the service platform facilitates communication session between user and service representative. The service platform may include a voice communication platform, a chat or instant message platform, a text message platform, an email platform, and/or the like. Correspondingly, the interaction may include a voice call, a chat session, a text message exchange, and/or an email exchange associated with a service (e.g., a customer service) provided by an entity associated with the service representative.

As further shown in FIG. 3A, and by reference number 320, the NBA management platform and/or service representative may obtain user information associated with the consumer. For example, the NBA management platform may monitor, in real-time, an ongoing interaction between the service representative and the consumer.

In some implementations, the NBA management platform may utilize one or more models and/or a combination of techniques to determine contextual information associated with the interaction and/or obtain certain information from the interaction (e.g., a consumer identification, such as a name, account number, and/or the like). For example, such models or techniques may include natural language processing (NLP), sentiment analysis, classification, bag-of-words processing, K-means clustering, random forests, stochastic gradient boosting machines, neural networks, and/or the like.

In this way, the NBA management platform may monitor, detect, and/or provide consumer information and/or contextual information associated with the interaction to determine simulation data for a simulation of the interaction that can be used to determine an NBA during the interaction.

As shown in FIG. 3B, and by reference number 330, the NBA management platform, via a scenario generator, configures operational parameters of the interaction. For example, based on identified contextual information, the scenario generator may set the operational parameters of the simulated data. As described herein, the contextual information may include real-time information, such as trends associated with the service, a type of communication medium being used, a sentiment of the interaction (e.g., a sentiment of the consumer), a purpose for the ongoing interaction (e.g., whether the consumer wants to cancel the service, complain about the service, become a new subscriber, and/or the like).

In this way, the NBA management platform may configure a scenario for the simulation that corresponds to the interaction.

As further shown in FIG. 3B, and by reference number 340, the NBA management platform, via the rules management module, determines rules for a transaction of the interaction. For example, the transaction may include or be associated with an offer to the consumer, an alteration to a service agreement, a payment for the service, and/or the like, and the rules may correspond to certain constraints for that transaction. In some implementations, the NBA management platform may determine the rules based on identifying (e.g., from the contextual information), information associated with the consumer, the service involved in the interaction, and/or the like. The rules management module may obtain the rules from the rules database based on particular information associated with the consumer, the interaction, and/or the like. For example, the rules may be specific to consumer information (e.g., personal information, activity, financial information, and/or the like) associated with the consumer. In a more specific example, the NBA management platform, via the rules management module, may identify that the consumer is a subscriber, and obtain subscriber information specific to the subscriber, to determine a current service agreement with the subscriber (e.g., terms of the service agreement). In such an example, the terms of the service agreement may correspond to the rules associated with the service. Accordingly, the NBA management platform may determine the rules for the simulation data to permit the simulation module, using a simulation model, to simulate the interaction according to the consumer information and operational parameters identified by the scenario generator.

In this way, the NBA management platform may determine the rules for the simulation that correspond to the consumer and/or service associated with the interaction.

As further shown in FIG. 3B, and by reference number 350, the NBA management platform, via the simulation module, iteratively simulates interactions according to the parameters and/or various sets of rules. For example, during the ongoing interaction, the NBA management platform may simulate the interaction to predict a probability of a desired outcome of the ongoing interaction (e.g., an outcome that satisfies an NBA threshold) according to the identified operational parameters set of rules, and/or user information.

As described herein, the simulation model of the simulation module may be trained according to historical data associated with a plurality of previous interactions corresponding to the ongoing interaction (e.g., that have the same or similar rules and/or operational parameters) and a plurality of subscribers of the service that are associated (e.g., have one or more same or similar characteristics) as the consumer of the interaction.

The NBA management platform, via the simulation module, may iteratively simulate the interaction by adjusting the rules for various simulations until an NBA threshold is satisfied, as described herein. Accordingly, between each iteration, the NBA management platform may determine that the probability does not satisfy a next best action threshold and determine various updates to the rules until the NBA management platform detects that a probability of an outcome of the simulation satisfies the next best action threshold. In such a case, the rules used to enable a simulation to provide an outcome that satisfies the NBA threshold may correspond to an NBA for the interaction.

In this way, the NBA management platform may iteratively simulate the interaction using a variety of rules to determine an NBA for the interaction.

As shown in FIG. 3C, and by reference number 360, the NBA management platform provides the NBA to the service platform and/or service representative. For example, the NBA management platform, according to the above identified set of rules that provided an outcome from a simulation that satisfied the NBA threshold, may generate an NBA output according to that set of rules. Further, the NBA management platform may provide the NBA output to a user device of the service representative to enable the service representative to perform the NBA during the ongoing interaction. Additionally, or alternatively, the NBA management platform may provide the NBA through the service platform (e.g., as an email, as a display of an offer corresponding to the NBA, and/or the like).

In this way, the NBA management platform may provide the NBA, to permit the NBA to be performed.

As further shown in FIG. 3C, and by reference number 370, the service representative and/or service platform performs the NBA. For example, the service representative and/or service platform may make an offer for a service agreement for the service that corresponds to the set of rules of the NBA.

In this way, an NBA may be determined and performed according to specific information associated with an ongoing interaction to improve a likelihood of a desired outcome of the interaction.

As indicated above, FIGS. 3A-3C are provided merely as one or more examples. Other examples may differ from what is described with regard to FIGS. 3A-3C.

Accordingly, as described herein, the NBA management platform enables an NBA to be determined, provided, and/or performed in association with a service. The NBA management platform may simulate one or more interactions to identify scenarios, rules, and/or consumers that would be associated with a highest likelihood of success during an interaction involving an NBA. In this way, resources (e.g., computing resources, communication resources, and/or the like) can be conserved during interactions that do not include performance of an NBA as determined herein. Furthermore, the NBA may be associated with an ongoing interaction to improve a user experience associated with the interaction, resulting in less variation or change to service performance data of a service, which may require additional or more frequent monitoring and/or maintenance. In other words, the NBA management platform may enable an NBA to be proactively determined for an interaction with a consumer before a negative experience (e.g., degraded service performance) or event (e.g., a subscriber dropping a service or complaining about the service) that could require reactively determining an NBA for an interaction with that consumer.

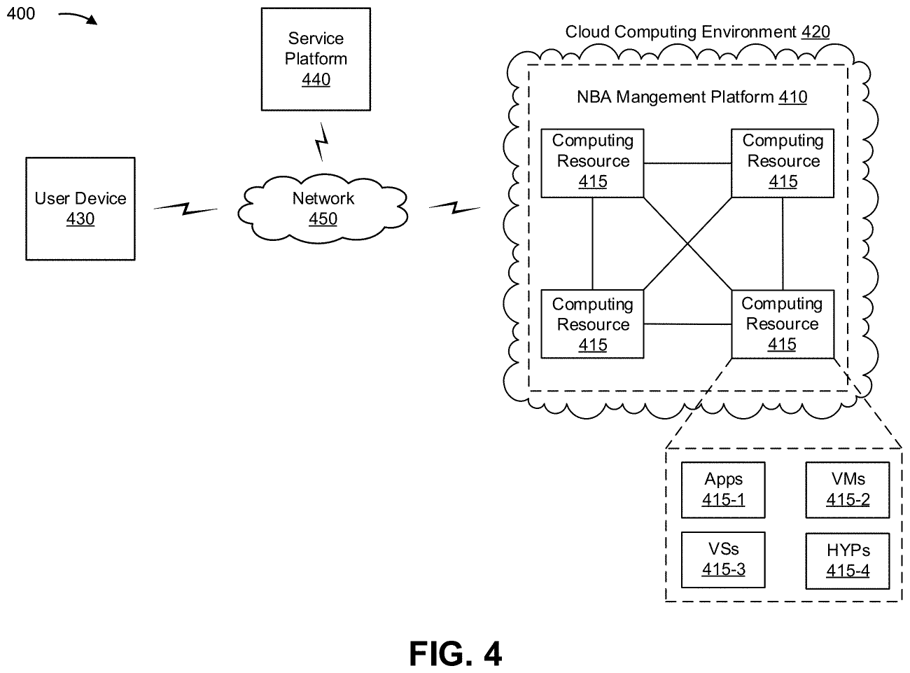

FIG. 4 is a diagram of an example environment 400 in which systems and/or methods described herein may be implemented. As shown in FIG. 4, environment 400 may include an NBA management platform 410 hosted by computing resources 415 of a cloud computing environment 420, one or more user devices 430 (referred to herein individually as “user device 430,” and collectively as “user devices 430”), a service platform 440, and a network 450. Devices of environment 400 may interconnect via wired connections, wireless connections, or a combination of wired and wireless connections.

NBA management platform 410 includes one or more computing resources assigned to determine and/or provide an NBA as described herein. For example, NBA management platform 410 may be a platform implemented by cloud computing environment 420 that may determine simulation data for a simulation of an interaction, perform the simulation, and determine from the simulation the NBA for the interaction. As described herein, NBA management platform 410 may iteratively determine/adjust the simulation data to iteratively perform simulations corresponding to the iteratively determined/adjusted simulation data. In some implementations, NBA management platform 410 is implemented by computing resources 415 of cloud computing environment 420.

NBA management platform 410 may include a server device or a group of server devices. In some implementations, NBA management platform 410 may be hosted in cloud computing environment 420. Notably, while implementations described herein may describe NBA management platform 410 as being hosted in cloud computing environment 420, in some implementations, NBA management platform 410 may be non-cloud-based or may be partially cloud-based.

Cloud computing environment 420 includes an environment that delivers computing as a service, whereby shared resources, services, and/or the like may be provided to user device 430. Cloud computing environment 420 may provide computation, software, data access, storage, and/or other services that do not require end-user knowledge of a physical location and configuration of a system and/or a device that delivers the services. As shown, cloud computing environment 420 may include one or more computing resources 415.

Computing resource 415 includes one or more personal computers, workstation computers, server devices, or another type of computation and/or communication device. In some implementations, computing resource 415 may host NBA management platform 410. The cloud resources may include compute instances executing in computing resource 415, storage devices provided in computing resource 415, data transfer devices provided by computing resource 415, and/or the like. In some implementations, computing resource 415 may communicate with other computing resources 415 via wired connections, wireless connections, or a combination of wired and wireless connections.

As further shown in FIG. 4, computing resource 415 may include a group of cloud resources, such as one or more applications (“APPs”) 415-1, one or more virtual machines (“VMs”) 415-2, virtualized storage (“VSs”) 415-3, one or more hypervisors (“HYPs”) 415-4, or the like.

Application 415-1 includes one or more software applications that may be provided to or accessed by user device 430. Application 415-1 may eliminate a need to install and execute the software applications on user device 430. For example, application 415-1 may include software associated with NBA management platform 410 and/or any other software capable of being provided via cloud computing environment 420. In some implementations, one application 415-1 may send/receive information to/from one or more other applications 415-1, via virtual machine 415-2.

Virtual machine 415-2 includes a software implementation of a machine (e.g., a computer) that executes programs like a physical machine. Virtual machine 415-2 may be either a system virtual machine or a process virtual machine, depending upon use and degree of correspondence to any real machine by virtual machine 415-2. A system virtual machine may provide a complete system platform that supports execution of a complete operating system (“OS”). A process virtual machine may execute a single program and may support a single process. In some implementations, virtual machine 415-2 may execute on behalf of a user device (e.g., user device 430), and may manage infrastructure of cloud computing environment 420, such as data management, synchronization, or long-duration data transfers.

Virtualized storage 415-3 includes one or more storage systems and/or one or more devices that use virtualization techniques within the storage systems or devices of computing resource 415. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 415-4 provides hardware virtualization techniques that allow multiple operating systems (e.g., “guest operating systems”) to execute concurrently on a host computer, such as computing resource 415. Hypervisor 415-4 may present a virtual operating platform to the guest operating systems and may manage the execution of the guest operating systems. Multiple instances of a variety of operating systems may share virtualized hardware resources.

User device 430 includes one or more devices capable of receiving, generating, storing, processing, and/or providing information associated with an NBA, as described herein. For example, user device 430 may include a communication and/or computing device, such as a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device. User device 430 may correspond to a user device of a consumer and/or a user device of a service representative, as described herein.

Service platform 440 includes a server device (e.g., a host server, a web server, an application server, and/or the like), a data center device, or a similar device. In some implementations, the user may engage in a communication session via service platform 440. In some implementations, service platform 440 may perform one or more operations to identify and/or indicate a user (e.g., a consumer) to NBA management platform 410. For example, the service platform may include a chatbot and/or other type of automated system to obtain information associated with a party involved in the communication session.

Network 450 includes one or more wired and/or wireless networks. For example, network 450 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 4 are provided as one or more examples. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

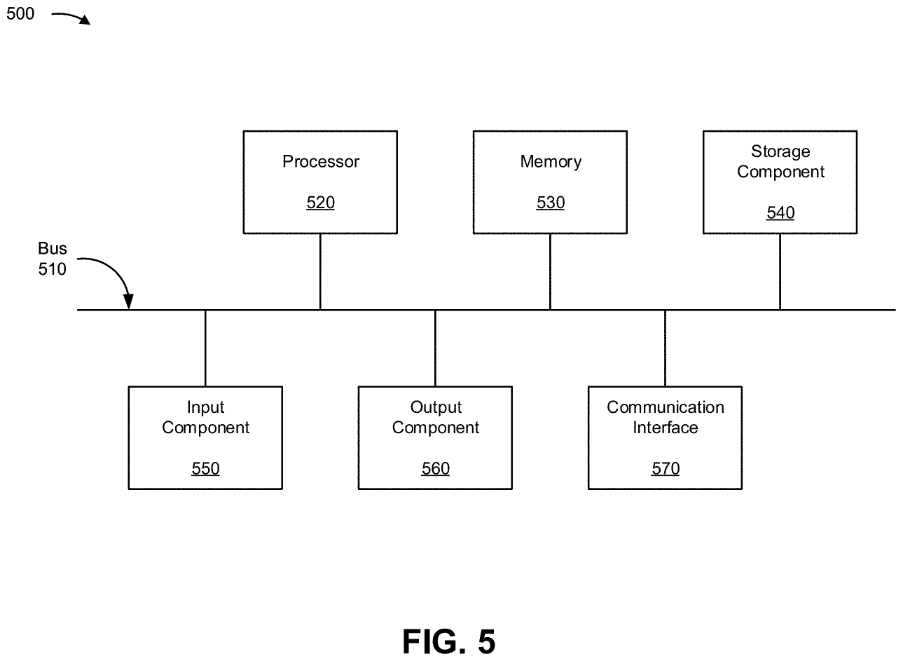

FIG. 5 is a diagram of example components of a device 500. Device 500 may correspond to NBA management platform 410, computing resource 415, user device 430, and/or service platform 440. In some implementations, device 500 may include one or more devices 500 and/or one or more components of device 500. As shown in FIG. 5, device 500 may include a bus 510, a processor 520, a memory 530, a storage component 540, an input component 550, an output component 560, and a communication interface 570.

Bus 510 includes a component that permits communication among multiple components of device 500. Processor 520 is implemented in hardware, firmware, and/or a combination of hardware and software. Processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a component for determining location (e.g., a global positioning system (GPS) component) and/or a sensor (e.g., an accelerometer, a gyroscope, an actuator, another type of positional or environmental sensor, and/or the like). Output component 560 includes a component that provides output information from device 500 (via, e.g., a display, a speaker, a haptic feedback component, an audio or visual indicator, and/or the like).

Communication interface 570 includes a transceiver-like component (e.g., a transceiver, a separate receiver, a separate transmitter, and/or the like) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. As used herein, the term “computer-readable medium” refers to a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

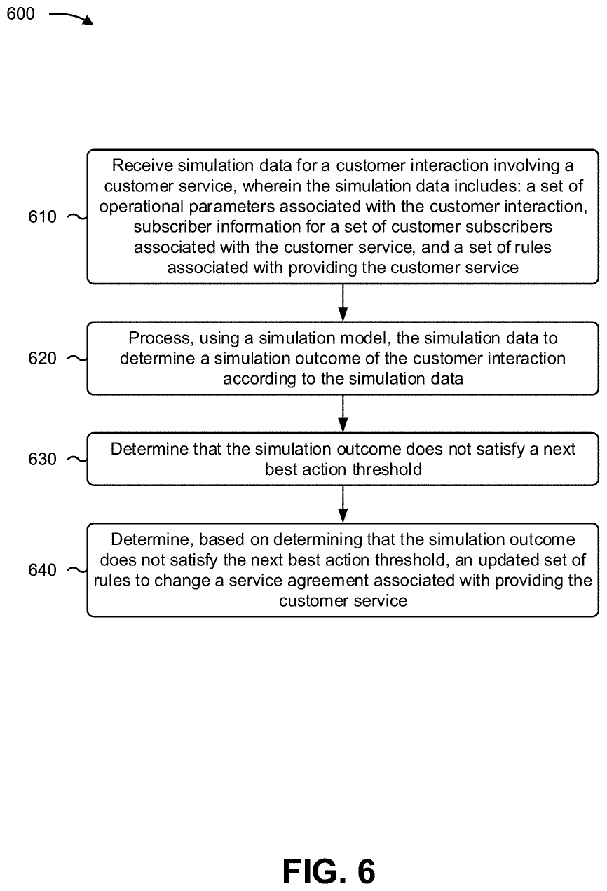

FIG. 6 is a flowchart of an example process 600 associated with an NBA management platform described herein. In some implementations, one or more process blocks of FIG. 6 may be performed by an NBA management platform (e.g., NBA management platform 410). In some implementations, one or more process blocks of FIG. 6 may be performed by another device or a group of devices separate from or including the NBA management platform, such as a user device (e.g., user device 430), a service platform (e.g., service platform 440), and/or the like.

As shown in FIG. 6, process 600 may include receiving simulation data for a customer interaction involving a customer service, wherein the simulation data includes: a set of operational parameters associated with the customer interaction, subscriber information for a set of customer subscribers associated with the customer service, and a set of rules associated with providing the customer service (block 610). For example, the NBA management platform (e.g., using processor 320, memory 330, storage component 340, input component 350, output component 360, communication interface 370 and/or the like) may receive simulation data for a customer interaction involving a customer service, as described above. In some implementations, the simulation data includes a set of operational parameters associated with the customer interaction, subscriber information for a set of customer subscribers associated with the customer service, and a set of rules associated with providing the customer service.

As further shown in FIG. 6, process 600 may include processing, using a simulation model, the simulation data to determine a simulation outcome of the customer interaction according to the simulation data (block 620). For example, the NBA management platform (e.g., using processor 320, memory 330, storage component 340, input component 350, output component 360, communication interface 370 and/or the like) may process, using a simulation model, the simulation data to determine a simulation outcome of the customer interaction according to the simulation data, as described above.

As further shown in FIG. 6, process 600 may include determining that the simulation outcome does not satisfy a next best action threshold (block 630). For example, the NBA management platform (e.g., using processor 320, memory 330, storage component 340, input component 350, output component 360, communication interface 370 and/or the like) may determine that the simulation outcome does not satisfy a next best action threshold, as described above.

As further shown in FIG. 6, process 600 may include determining, based on determining that the simulation outcome does not satisfy the next best action threshold, an updated set of rules to change a service agreement associated with providing the customer service (block 640). For example, the NBA management platform (e.g., using processor 320, memory 330, storage component 340, input component 350, output component 360, communication interface 370 and/or the like) may determine, based on determining that the simulation outcome does not satisfy the next best action threshold, an updated set of rules to change a service agreement associated with providing the customer service, as described above.

Process 600 may include additional implementations, such as any single implementation or any combination of implementations described below and/or in connection with one or more other processes described elsewhere herein.

In a first implementation, the method comprises: prior to receiving the simulation data, monitoring the subscriber information to identify a trend associated with providing the service to the set of subscribers, and determining that the trend indicates that a quantity of the set of subscribers is decreasing, and the simulation data is received based on determining that the trend indicates that the quantity of the set of subscribers is decreasing and obtaining the simulation data from a data structure associated with the simulation model. In a second implementation, alone or in combination with the first implementation, the simulation model is trained according to historical data associated with a plurality of previous customer interactions involving the customer service.

In a third implementation, alone or in combination with one or more of the first and second implementations, process 600 may include receiving real-time data for a real-time customer interaction involving the customer service, generating a next best action output according to the updated set of rules and based on the real-time data, and providing the next best action output to enable a next best action suggestion for engaging a customer in the customer interaction. In a fourth implementation, alone or in combination with one or more of the first through third implementations, determining the updated set of rules may include at least one of: altering a weighting parameter of a rule of the set of rules, adding a new rule to the set of rules, or removing a rule from the set of rules.

In a fifth implementation, alone or in combination with one or more of the first through fourth implementations, the simulation outcome is representative of a probability that the set of subscribers engage in a service agreement for the service according to the set of rules and the next best action threshold corresponds to a threshold probability. In a sixth implementation, alone or in combination with one or more of the first through fifth implementations, the set of rules correspond to terms of a service agreement for providing the service.

In a seventh implementation, alone or in combination with one or more of the first through sixth implementations, the customer interaction is between a subscriber of the set of subscribers and a service representative, and the next best action output indicates at least one of: a communication medium for the service representative to use to engage in corresponding interactions with the subscriber, timing associated with the corresponding customer interaction with the subscriber, or terms of a service agreement that the service representative may offer to the subscriber in association with providing the service.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

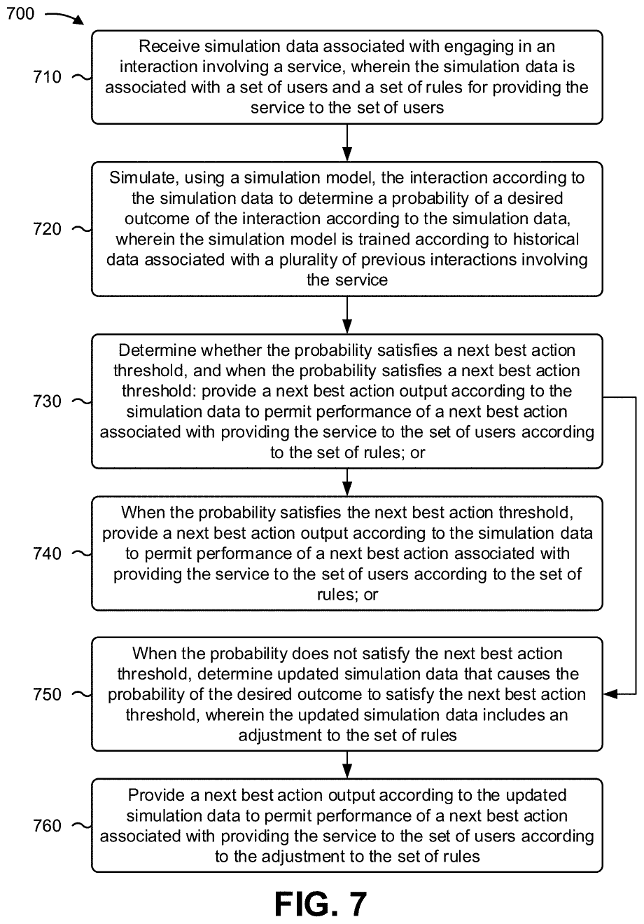

FIG. 7 is a flowchart of an example process 700 associated with an NBA management platform described herein. In some implementations, one or more process blocks of FIG. 7 may be performed by an NBA management platform (e.g., NBA management platform 410). In some implementations, one or more process blocks of FIG. 7 may be performed by another device or a group of devices separate from or including the NBA management platform, such as a user device (e.g., user device 430), a service platform (e.g., service platform 440), and/or the like.

As shown in FIG. 7, process 700 may include receiving simulation data associated with engaging in an interaction involving a service, wherein the simulation data is associated with a set of users and a set of rules for providing the service to the set of users (block 710). For example, the NBA management platform (e.g., using processor 520, memory 530, storage component 540, input component 550, output component 560, communication interface 570 and/or the like) may receive simulation data associated with engaging in an interaction involving a service, as described above. In some implementations, the simulation data is associated with a set of users and a set of rules for providing the service to the set of users.

As further shown in FIG. 7, process 700 may include simulating, using a simulation model, the interaction according to the simulation data to determine a probability of a desired outcome of the interaction according to the simulation data, wherein the simulation model is trained according to historical data associated with a plurality of previous interactions involving the service (block 720). For example, the NBA management platform (e.g., using processor 520, memory 530, storage component 540, input component 550, output component 560, communication interface 570 and/or the like) may simulate, using a simulation model, the interaction according to the simulation data to determine a probability of a desired outcome of the interaction according to the simulation data, as described above. In some implementations, the simulation model is trained according to historical data associated with a plurality of previous interactions involving the service.

As further shown in FIG. 7, process 700 may include determining whether the probability satisfies a next best action threshold, and when the probability satisfies a next best action threshold: providing a next best action output according to the simulation data to permit performance of a next best action associated with providing the service to the set of users according to the set of rules (block 730). For example, the NBA management platform (e.g., using processor 520, memory 530, storage component 540, input component 550, output component 560, communication interface 570 and/or the like) may determine whether the probability satisfies a next best action threshold, as described above.

As further shown in FIG. 7, process 700 may alternatively include, when the probability satisfies a next best action threshold, providing a next best action output according to the simulation data to permit performance of a next best action associated with providing the service to the set of users according to the set of rules (block 740). For example, the NBA management platform (e.g., using processor 520, memory 530, storage component 540, input component 550, output component 560, communication interface 570 and/or the like) may, when the probability satisfies a next best action threshold, provide a next best action output according to the simulation data to permit performance of a next best action associated with providing the service to the set of users according to the set of rules, as described above.

As further shown in FIG. 7, process 700 may alternatively include, when the probability does not satisfy the next best action threshold, determining updated simulation data that causes the probability of the desired outcome to satisfy the next best action threshold, wherein the updated simulation data includes an adjustment to the set of rules (block 750). For example, the NBA management platform (e.g., using processor 520, memory 530, storage component 540, input component 550, output component 560, communication interface 570 and/or the like) may, when the probability does not satisfy the next best action threshold, determine updated simulation data that causes the probability of the desired outcome to satisfy the next best action threshold, as described above. In some implementations, the updated simulation data includes an adjustment to the set of rules.

As further shown in FIG. 7, process 700 may include, when the probability does not satisfy the next best action threshold, providing a next best action output according to the updated simulation data to permit performance of a next best action associated with providing the service to the set of users according to the adjustment to the set of rules (block 760). For example, the NBA management platform (e.g., using processor 520, memory 530, storage component 540, input component 550, output component 560, communication interface 570 and/or the like), when the probability does not satisfy the next best action threshold, may provide a next best action output according to the updated simulation data to permit performance of a next best action associated with providing the service to the set of users according to the adjustment to the set of rules, as described above.

Process 700 may include additional implementations, such as any single implementation or any combination of implementations described below and/or in connection with one or more other processes described elsewhere herein.

In a first implementation, the simulation data is received via a user interface associated with the simulation model to permit a service provider to simulate the interaction. In a second implementation, alone or in combination with the first implementation, the updated simulation data is determined based on prompting, via a user device, a service representative to update the set of rules via a user input, and receiving, via the user device, the updated simulation data via the user input.

In a third implementation, alone or in combination with one or more of the first and second implementations, the updated simulation data is determined based on: iteratively processing iterations of adjustments to the simulated data until the updated simulation data is identified; requesting, via a user device, approval of the updated simulation data from a service representative, and adjusting the simulation data to be the updated simulation data based on receiving a user input that indicates approval of the updated simulation data.

In a fourth implementation, alone or in combination with one or more of the first through third implementations, the desired outcome corresponds to one or more of the set of users engaging in a service agreement for the service based on the interaction. In a fifth implementation, alone or in combination with one or more of the first through fourth implementations, the set of users are associated with one another based on having a same or similar user characteristic, and the set of rules correspond to terms of a service agreement for providing the service.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

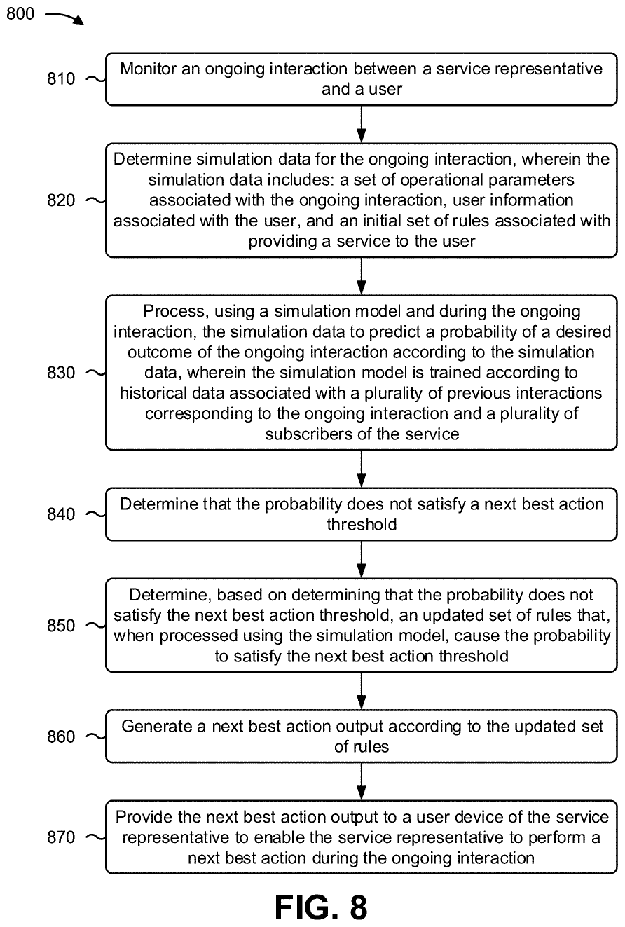

FIG. 8 is a flowchart of an example process 800 associated with an NBA management platform described herein. In some implementations, one or more process blocks of FIG. 8 may be performed by an NBA management platform (e.g., NBA management platform 410). In some implementations, one or more process blocks of FIG. 8 may be performed by another device or a group of devices separate from or including the NBA management platform, such as a user device (e.g., user device 430), a service platform (e.g., service platform 440), and/or the like.

As shown in FIG. 8, process 800 may include monitoring an ongoing interaction between a service representative and a user (block 810). For example, the NBA management platform (e.g., using processor 520, memory 530, storage component 540, input component 550, output component 560, communication interface 570 and/or the like) may monitor an ongoing interaction between a service representative and a user, as described above.

As further shown in FIG. 8, process 800 may include determining simulation data for the ongoing interaction, wherein the simulation data includes: a set of operational parameters associated with the ongoing interaction, user information associated with the user, and an initial set of rules associated with providing a service to the user (block 820). For example, the NBA management platform (e.g., using processor 520, memory 530, storage component 540, input component 550, output component 560, communication interface 570 and/or the like) may determine simulation data for the ongoing interaction, as described above. In some implementations, the simulation data includes a set of operational parameters associated with the ongoing interaction, user information associated with the user, and an initial set of rules associated with providing a service to the user.

As further shown in FIG. 8, process 800 may include processing, using a simulation model and during the ongoing interaction, the simulation data to predict a probability of a desired outcome of the ongoing interaction according to the simulation data, wherein the simulation model is trained according to historical data associated with a plurality of previous interactions corresponding to the ongoing interaction and a plurality of subscribers of the service (block 830). For example, the NBA management platform (e.g., using processor 520, memory 530, storage component 540, input component 550, output component 560, communication interface 570 and/or the like) may process, using a simulation model and during the ongoing interaction, the simulation data to predict a probability of a desired outcome of the ongoing interaction according to the simulation data, as described above. In some implementations, the simulation model is trained according to historical data associated with a plurality of previous interactions corresponding to the ongoing interaction and a plurality of subscribers of the service.

As further shown in FIG. 8, process 800 may include determining that the probability does not satisfy a next best action threshold (block 840). For example, the NBA management platform (e.g., using processor 520, memory 530, storage component 540, input component 550, output component 560, communication interface 570 and/or the like) may determine that the probability does not satisfy a next best action threshold, as described above.

As further shown in FIG. 8, process 800 may include determining, based on determining that the probability does not satisfy the next best action threshold, an updated set of rules that, when processed using the simulation model, cause the probability to satisfy the next best action threshold (block 850). For example, the NBA management platform (e.g., using processor 520, memory 530, storage component 540, input component 550, output component 560, communication interface 570 and/or the like) may determine, based on determining that the probability does not satisfy the next best action threshold, an updated set of rules that, when processed using the simulation model, cause the probability to satisfy the next best action threshold, as described above.

As further shown in FIG. 8, process 800 may include generating a next best action output according to the updated set of rules (block 860). For example, the NBA management platform (e.g., using processor 520, memory 530, storage component 540, input component 550, output component 560, communication interface 570 and/or the like) may generate a next best action output according to the updated set of rules, as described above.

As further shown in FIG. 8, process 800 may include providing the next best action output to a user device of the service representative to enable the service representative to perform a next best action during the ongoing interaction (block 870). For example, the NBA management platform (e.g., using processor 520, memory 530, storage component 540, input component 550, output component 560, communication interface 570 and/or the like) may provide the next best action output to a user device of the service representative to enable the service representative to perform a next best action during the ongoing interaction, as described above.

Process 800 may include additional implementations, such as any single implementation or any combination of implementations described below and/or in connection with one or more other processes described elsewhere herein.

In a first implementation, the simulation data is determined based on a user input from the user device of the service representative. In a second implementation, alone or in combination with the first implementation, the set of operational parameters are determined using a natural language processing model that analyzes the ongoing interaction, and the set of operational parameters include at least one of: a sentiment of the user determined using a sentiment analysis of the natural language processing model, or a purpose for the ongoing interaction.

In a third implementation, alone or in combination with one or more of the first and second implementations, the initial set of rules are determined based on: identifying that the user is a subscriber of the service; obtaining subscription information associated with the user, the subscription information including terms of a service agreement corresponding to initial set of rules, and the updated set of rules corresponding to an adjustment to the terms of the service agreement.

In a fourth implementation, alone or in combination with one or more of the first through third implementations, the updated set of rules is determined based on iteratively processing iterations of adjustments to the initial set of rules until the updated set of rules is identified. In a fifth implementation, alone or in combination with one or more of the first through fourth implementations, the desired outcome corresponds to the user engaging in a service agreement during the ongoing interaction.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, simulation data for a customer interaction involving a customer service,
wherein the simulation data includes:
a set of operational parameters associated with the customer interaction,
subscriber information for a set of customer subscribers associated with the customer service, and
a set of rules associated with providing the customer service;
processing, by the device and using a simulation model, the simulation data to determine a simulation outcome of the customer interaction according to the simulation data;
determining, by the device, that the simulation outcome does not satisfy a next best action threshold; and
determining, by the device and based on determining that the simulation outcome does not satisfy the next best action threshold, updated set of rules to change a service agreement associated with providing the customer service.

2. The method of claim 1, wherein the method comprises:
prior to receiving the simulation data, monitoring the subscriber information to identify a trend associated with providing the service to the set of subscribers; and
determining that the trend indicates that a quantity of the set of subscribers is decreasing, and
wherein the simulation data is received based on determining that the trend indicates that the quantity of the set of subscribers is decreasing and obtaining the simulation data from a data structure associated with the simulation model.

3. The method of claim 1, wherein the simulation model is trained according to historical data associated with a plurality of previous customer interactions involving the customer service.

4. The method of claim 1, wherein the method comprises:
receiving real-time data for a real-time customer interaction involving the customer service;
generating a next best action output according to the updated set of rules and based on the real-time data; and
providing the next best action output to enable a next best action suggestion for engaging a customer in the customer interaction.

5. The method of claim 1, wherein determining the updated set of rules comprises at least one of:
altering a weighting parameter of a rule of the set of rules to determine the updated simulation data,
adding a new rule to the set of rules to determine the updated simulation data, or
removing a rule from the set of rules to determine the updated simulation data.

6. The method of claim 1, wherein the simulation outcome is representative of a probability that the set of subscribers engage in a service agreement for the service according to the set of rules and the next best action threshold corresponds to a threshold probability.

7. The method of claim 1, wherein the set of rules correspond to terms of a service agreement for providing the service.

8. The method of claim 1, wherein the customer interaction is between a subscriber of the set of customer subscribers and a service representative, and the next best action output indicates at least one of:
a communication medium for the service representative to use to engage in corresponding interactions with the subscriber,
timing associated with the corresponding customer interaction with the subscriber, or
terms of a service agreement that the service representative may offer to the subscriber in association with providing the service.

9. A device, comprising:
one or more memories; and
one or more processors communicatively coupled to the one or more memories, configured to:
receive simulation data associated with engaging in an interaction involving a service,
wherein the simulation data is associated with a set of users and a set of rules for providing the service to the set of users;
simulate, using a simulation model, the interaction according to the simulation data to determine a probability of a desired outcome of the interaction according to the simulation data,
wherein the simulation model is trained according to historical data associated with a plurality of previous interactions involving the service;
determine whether the probability satisfies a next best action threshold; and
when the probability satisfies a next best action threshold:
provide a next best action output according to the simulation data to permit performance of a next best action associated with providing the service to the set of users according to the set of rules; or
when the probability does not satisfy the next best action threshold:
determine updated simulation data that causes the probability of the desired outcome to satisfy the next best action threshold,
wherein the updated simulation data includes an adjustment to the set of rules, and
provide a next best action output according to the updated simulation data to permit performance of a next best action associated with providing the service to the set of users according to the adjustment to the set of rules.

10. The device of claim 9, wherein the simulation data is received via a user interface associated with the simulation model to permit a service provider to simulate the interaction.

11. The device of claim 9, wherein the updated simulation data is determined based on:
prompting, via a user device, a service representative to update the set of rules via a user input; and
receiving, via the user device, the updated simulation data via the user input.

12. The device of claim 9, wherein the updated simulation data is determined based on:
iteratively processing iterations of adjustments to the simulated data until the updated simulation data is identified;
requesting, via a user device, approval of the updated simulation data from a service representative; and
adjusting the simulation data to be the updated simulation data based on receiving a user input that indicates approval of the updated simulation data.

13. The device of claim 9, wherein the desired outcome corresponds to one or more of the set of users engaging in a service agreement for the service based on the interaction.

14. The device of claim 9, wherein the set of users are associated with one another based on having a same user characteristic, and
wherein the set of rules correspond to terms of a service agreement for providing the service.

15. A non-transitory computer-readable medium storing instructions, the instructions comprising:
one or more instructions that, when executed by one or more processors, cause the one or more processors to:
monitor an ongoing interaction between a service representative and a user;
determine simulation data for the ongoing interaction,
wherein the simulation data includes:
a set of operational parameters associated with the ongoing interaction,
user information associated with the user, and
an initial set of rules associated with providing a service to the user;
process, using a simulation model and during the ongoing interaction, the simulation data to predict a probability of a desired outcome of the ongoing interaction according to the simulation data,
wherein the simulation model is trained according to historical data associated with a plurality of previous interactions corresponding to the ongoing interaction and a plurality of subscribers of the service;
determine that the probability does not satisfy a next best action threshold;
determine, based on determining that the probability does not satisfy the next best action threshold, an updated set of rules that, when processed using the simulation model, cause the probability to satisfy the next best action threshold;
generate a next best action output according to the updated set of rules; and
provide the next best action output to a user device of the service representative to enable the service representative to perform a next best action during the ongoing interaction.

16. The non-transitory computer-readable medium of claim 15, wherein the simulation data is determined based on a user input from the user device of the service representative.

17. The non-transitory computer-readable medium of claim 15, wherein the set of operational parameters are determined using a natural language processing model that analyzes the ongoing interaction, and
wherein the set of operational parameters include at least one of:
a sentiment of the user determined using a sentiment analysis of the natural language processing model, or
a purpose for the ongoing interaction.

18. The non-transitory computer-readable medium of claim 15, wherein the initial set of rules are determined based on:
identifying that the user is a subscriber of the service; and
obtaining subscription information associated with the user, wherein the subscription information includes terms of a service agreement corresponding to initial set of rules, and
wherein the updated set of rules correspond to an adjustment to the terms of the service agreement.

19. The non-transitory computer-readable medium of claim 15, wherein the updated set of rules is determined based on iteratively processing iterations of adjustments to the initial set of rules until the updated set of rules is identified.

20. The non-transitory computer-readable medium of claim 15, wherein the desired outcome corresponds to the user engaging in a service agreement during the ongoing interaction.
